(19) United States
(12) Patent Application Publication
(10) Pub. No.: US 2012/0070566 A1
(43) Pub. Date: Mar. 22, 2012

(54) Dispersing Agent of MWCNTs and the Method for Preparation and Application of Homogeneous MWCNTs Dispersion

(75) Inventors: Sea-Fue Wang, Taipei (TW); Chung-Kuang Yang, Taipei (TW); S. Ashok Kumar, Taipei (TW); I-lin Ho, Taipei (TW)

(73) Assignee: NATIONAL TAIPEI UNIVERSITY OF TECHNOLOGY, Taipei (TW)

(21) Appl. No.: 12/953,525

(22) Filed: Nov. 24, 2010

(30) Foreign Application Priority Data
Sep. 17, 2010 (TW) 099131660

(51) Int. Cl. B05D 5/12; H01B 1/24; B82Y 30/00

(52) U.S. Cl. 427/77; 252/510; 977/752

(57) ABSTRACT

Dispersing agent of MWCNTs and the method for preparation of homogeneous MWCNTs dispersion are disclosed. Acid yellow 9(4-amino-1-1′-azobenzene-3,4′-disulfonic acid, AY) is a good agent for multi-walled carbon nanotubes (MWCNTs). MWCNTs dispersed in AY solution was remained stable about three months and even remained stable after centrifugation at 10000 rpm for 30 min. Using MWCNTs/AY dispersion, thin-films were prepared on indium tin oxide coated glass electrode and glassy carbon electrode. Further, dried firms of MWCNTs/AY were subjected to electropolymerization in 0.1 M H₂SO₄ solution. Adsorbed AY molecules on MWCNTs get polymerized and then yield a polymer-MWCNTs nanocomposite film on electrode surface so as to modify properties of the electrode.

### FIELD OF THE INVENTION

The present invention relates to a dispersing agent of MWCNTs and the method for preparation and application of steady-stated homogeneous dispersing MWCNTs.

### BACKGROUND OF THE INVENTION

Recently, carbon nanotubes (CNTs) and their nanocomposites, in which CNT is used as conducting filler, have been widely explored in material science and engineering. Further, CNTs have generated tremendous interest because of their unique combination of electric, mechanical, chemical, and thermal properties.

CNTs applications have been proposed in various fields, including electrochemical devices, field-emission devices, nanoscale electronic devices and sensors, among others. However, extensive applications of CNTs are still limited. One of the main challenges in CNTs research field is the dispersion and stabilization of CNTs in different solvent media and especially in aqueous solvents. The synthesized CNTs are often bundled together due to strong Van Der Waals interactions between the nanotubes. In resent years, great efforts have been made to disperse CNTs into aqueous solutions by the noncovalent method, using surfactant or polymers.

Dopamine (DA) plays a major role as a neurotransmitter or hormone in mammals and has an important function in motor control, motivation, learning, memory and signaling reward. L-Ascorbic acid (Vitamin C; hereinafter called AA) is used in large scale as an antioxidant in food, animal feed, beverage, pharmaceutical formulations and cosmetic application. AA is the major soluble antioxidant found in plants and is also an essential component of human nutrition. DA and AA are usually simultaneously detected by electrochemical sensor.

However, both DA and AA could be oxidized electrochemically at solid electrodes. Further, oxidation of DA and AA takes place in the same potential range on bare-electrodes, which results that the separation of the electrochemical response of DA and AA is difficult to be obtained by the simultaneous detection of the electrochemical sensor. In addition, oxidation products of DA or AA get adsorbed on electrode surface which is known as electrode fouling. These are the main problems associated with unmodified electrode.

Therefore, it is maybe an available approach that through the incorporation of CNTs into the polymer matrices to enhance the electrochemical, optical, and interfacial properties of electrodes because the resulting nanocomposites may exhibit characteristics that differ from those of the individual components. However, prior to modify electrode by using nanocomposites, preparation of homogenous dispersion of CNTs is a challenge task.

### BRIEF SUMMARY OF THE INVENTION

Accordingly, the present invention provides a dispersion agent of MWCNTs and the method of preparation of comprising stable homogeneous MWCNTs dispersion.

The dispersion agent of MWCNTs comprising stable homogeneous dispersed MWCNTs in a solution, wherein the solution is an acid yellow 9 solution (4-amino-1-1′-azobenzene-3,4′-disulfonic acid, AY).

In addition, the MWCNTs/AY dispersion is casted onto a conductive glass or a glassy carbon electrode (GCE) and dried in air-oven so as to form a dry film of MWCNTs/AY.

The electrochemical polymerization is performed by using MWCNTs/AY/GCE as a working electrode to form the polymerized-AY/MWCNTs/GCE.

The present invention provides an application of the polymerized-AY/MWCNTs/GCE which serve as a electrode of electrochemical sensor to simultaneously detect DA and AA.

In the present invention, AY is employed as an effective dispersing agent for MWCNTs. In addition, homogeneous thin-films of MWCNTs could be prepared on electrode surface for biosensing application. After electrochemical polymerization process, polymerized-AY/MWCNTs/GCE can be employed as a sensor for detection of AA and DA and a highly selectivity and sensitivity for AA and DA can be obtained.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1a shows schematic representation of aggregation of MWCNTs.

FIG. 1a shows schematic representation of AY assisted dispersion of MWCNTs.

FIG. 2. shows SEM image of dry films made from MWCNTs/AY dispersion.

### DETAILED DESCRIPTION THE INVENTION

The above purpose, further features, advantages, and benefits of the invention will become apparent in the following descriptions taken in conjunction with the following drawings. It is to be understood that the foregoing general description and following detailed descriptions of the preferred embodiments of this invention are exemplary and explanatory.

Without any other treatment, MWCNTs in the dispersion agent of the present invention is maintained in a state of dispersion for a span. In the present invention, MWCNTs are dispersed in an acid yellow 9, a 4-amino-1-1′-azobenzene-3,4′-disulfonic acid, hereafter called AY solution, wherein AY is dissolved in distilled water. In a preferred embodiment, the better dispersing effect of MWCNTs is obtained when the molar concentration of the AY solution is between about 0.1 to 25 mM.

In the preferred embodiment of the present invention, MWCNTs is dispersed in a 2.5 mM AY solution, hereinafter called MWCNTs dispersion. Firstly, 10 mg MWCNTs is dissolved in a 10 mL of AY solution. Thereafter, gentle sonication for 10 min and followed by stirring about 3 hrs are performed to disperse the MWCNTs in the AY solution. The followed experiences demonstrate that the MWCNTs/AY dispersion remained stable for three months at room temperature without any aggregation.

When the concentration of the MWCNTs is between about 0.1-10 mg/mL in the AY solution, more homogeneous dispersing effects will be obtained. For optimizing the concentration of the MWCNTs in the AY solution, the further experiments are carried out by varying the concentrations thereof from 0.5 mg/mL, 1 mg/mL, 1.5 mg/mL and 2 mg/mL in the AY solution and comparing the dispersing effects thereof. The 1 mg/mL MWCNTs dispersion in the AY solution is found to be the most stable and without aggregation among forgoing samples.

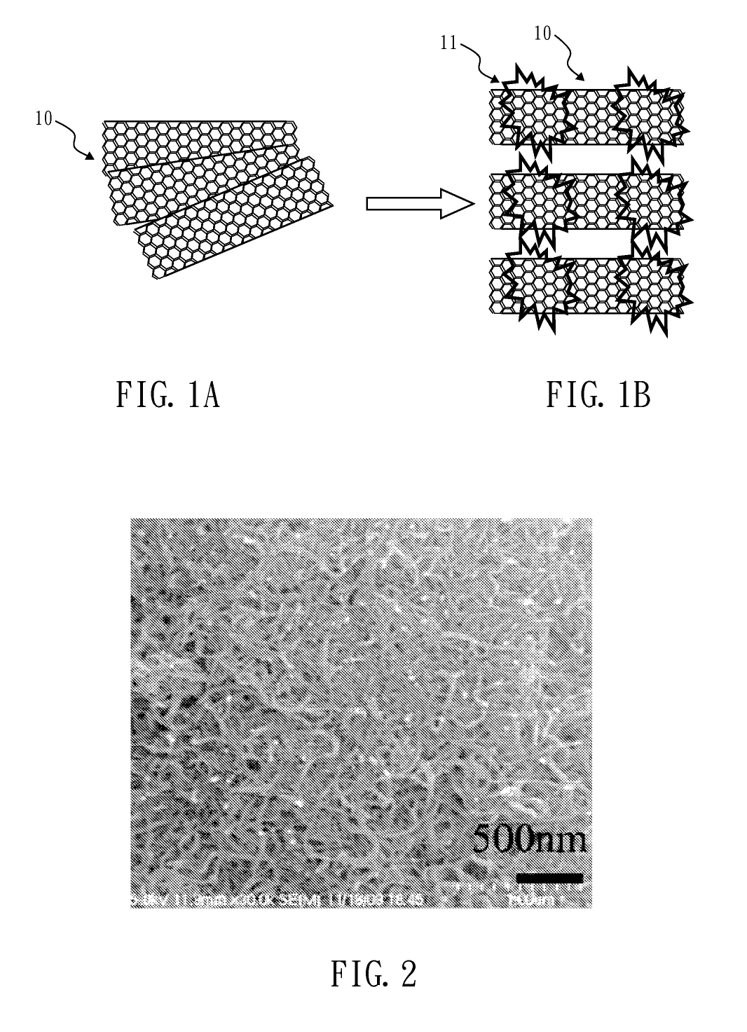

The mechanism for dispersing capability of the AY could be explained by its adsorption hysteresis on CNTs. Because different mechanisms, mainly hydrophobic interaction, π-π bonds, electrostatic interactions, and hydrogen bonds, etc., may act simultaneously. Each carbon atom in a CNT has a π electron orbit perpendicular to a CNT surface. Therefore, organic molecules containing π electrons can form π-π bonds with CNTs such as organic molecules with carbon double bonds (C═C) or benzene rings. FIG. 1A illustrates a schematic diagram of aggregation of MWCNTs without the AY and FIG. 1B shows a schematic diagram of MWCNTs with the AY assisted dispersion.

The present invention provides a method about applications of the MWCNT/AY dispersion. Examples shown are: the MWCNTs/AY dispersion casted onto a conductive glass, such as an ITO glass, or a glassy carbon electrode (GCE) and dried to form a film of MWCNTs/AY on the conductive glass or the glassy carbon electrode to modify the properties of the electrode.

In one preferred embodiment of the present invention, the method of application of MWCNT/AY dispersion comprises the steps of preparing a homogeneous MWCNTs/AY dispersion, casting a 200 μL of MWCNTs/AY dispersion onto an ITO glass and drying the MWCNTs/AY/ITO in an air-oven at 60° C. for 30 min to form a dry film on the ITO glass.

Please refer to FIG. 2, which shows SEM images of the dry films made from the MWCNTs/AY dispersion. It is confirmed that the AY is a good dispersing agent for the MWCNTs, as shown in FIG. 2. By this method, the homogeneous dry films of the MWCNTs are able to be prepared without doing any complex or special treatment on the nanotubes.

Another application of MWCNTs/AY solution is that modifying the properties of the GCE by preparing a dry film of MWCNTs/AY on the GCE in the similar way, which is used as a working electrode of electrochemical sensor to simultaneously detect AA and DA. In the preferred embodiment, the method comprises the steps of casting a 10 μL of MWCNTs/AY dispersion onto a pre-cleaned GCE and drying the MWCNTs/AY/GCE in an air-oven at 60° C. for 30 min to form a dry film of MWCNTs/AY on the GCE.

Thereafter, an electrochemical polymerization process is performed to form a polymerized-AY/MWCNTs on the GCE. The redox and the polymerization characteristics of the MWCNTs/AY film will be studied. The electrochemical polymerization is carried out with a conventional three-electrode system, wherein the GEC or the ITO glass is served as a working electrode, a platinum wire and Ag/AgCl electrode are, respectively, served an auxiliary electrode and a reference electrode,

In this embodiment, before performing the electrochemical polymerization, the MWCNTs/AY film modified GCE is thoroughly washed with double distilled water. Thereafter, the electrochemical polymerization is performed by a potential cycling between about −0.5 V and 2.0 V at a sweep rate of about 0.05 V/s in a 0.1 M H₂SO₄ using the MWCNTs/AY/GCE as a working electrode. From the CV cyclic voltammogram measurements, we have confirmed that the AY molecules are strongly adsorbed on the MWCNTs, which are not completely removed during washing with distilled water.

The polymerization process of the AY monomers which are adsorbed on the MWCNTs surface is completed after 10 consecutive cycles. The polymer structure of the AY is expected to be similar to that of the polyaniline. After a polymerization process, the polymerized-AY/MWCNTs electrode is thoroughly washed with distilled water and dried at room temperature.

In comparison with an unmodified GCE, the polymerized-AY/MWCNTs/GCE is found to have a higher sensitivity and more easier to separate the electrochemical responses comes from the dopamine (DA) or the L-Ascorbic acid (AA)

While the preferred embodiment of the invention has been illustrated and described, it will be appreciated that various changes and modifications can be made therein without departing from the spirit and scope of the invention.

What is claimed is:

1. A stabilizing dispersion multi-walled carbon nanotubes (MWCNTs) solution comprising: MWCNTs in an acid yellow 9 (4-amino-1-1′-azobenzene-3,4′-disulfonic acid; AY) solution.

2. The dispersion MWCNTs solution of claim 1, wherein the molar concentration of the acid yellow 9 solution is between about 0.1 to 25 mM acid yellow 9 dissolved in distilled water.

3. A method for preparation of homogeneous MWCNTs dispersion, the method comprising:
Preparing an acid yellow 9 (AY) solution; and
Dispersing MWCNTs with a predetermined weight into said acid yellow 9 (AY) solution by stirring to obtain a MWCNTs/AY dispersion.

4. The method for preparation of homogeneous MWCNTs dispersion of claim 3, wherein the molar concentration of the acid yellow 9 solution is between about 0.1 to 25 mM.

5. The method for preparation of homogeneous MWCNTs dispersion of claim 3, wherein the concentration of MWCNTs is between about 0.1-10 mg/mL in the AY solution.

6. The method for preparation of homogeneous MWCNTs dispersion of claim 3, further comprising:
casting the MWCNTs/AY dispersion onto a conductive glass or a glassy carbon electrode (GCE); and
drying to form a dry films of MWCNTs/AY on the conductive glass or the glassy carbon electrode.

7. The method for preparation of homogeneous MWCNTs dispersion of claim 6, further comprising performing an electrochemical polymerization by using the MWCNTs/AY/GCE as a working electrode to form a polymerized-AY/MWCNTs/GCE.

8. The method for preparation of homogeneous MWCNTs dispersion of claim 7, further comprising simultaneous detecting dopamine (DA) and L-Ascorbic acid (AA) by using polymerized-AY/MWCNTs/GCE as the electrode of the electrochemical sensor to separate the electrochemical responses of AA and DA.

9. A method of forming a polymer-MWCNTs modified electrode for selective detecting DA and AA, said modified electrode, comprising the steps of:
preparing an acid yellow 9 (AY) solution;
dispersing MWCNTs with a predetermined weight into said acid yellow 9 (AY) solution by stirring to obtain a MWCNTs/AY dispersion;
casting said MWCNTs/AY dispersion onto a conductive glass or a glassy carbon electrode (GCE);
drying to form a MWCNTs/AY film on the conductive glass or the glassy carbon electrode; and
polymerizing said AY/MWCNTs film to form a polymerized-AY/MWCNTs on the conductive glass or the glassy carbon electrode.

10. The dispersion agent of MWCNTs of claim 9, wherein the molar concentration of the acid yellow 9 solution is between about 0.1 to 25 mM, and the acid yellow 9 was dissolved in distilled water.
